(19) United States
(12) Patent Application Publication
(10) Pub. No.: US 2005/0275612 A1
(43) Pub. Date: Dec. 15, 2005

(54) Liquid Crystal Display Capable of Reducing Flicker and Method Thereof

(76) Inventors: Yu-Pin Chou, Miao- Li Hsien (TW); Shiu-Rong Tong, Kao-Hsiung City (TW); Wen- Hsia Kung, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,229

(22) Filed: Jun. 14, 2005

(30) Foreign Application Priority Data
Jun. 15, 2004 (TW) 093117195

(51) Int. Cl. G09G 3/36

(52) U.S. Cl. 345/96

(57) ABSTRACT

A method for controlling an LCD to display an image. The method includes receiving a display data flow, generating a polarity signal, generating a gray-scale signal according to the polarity signal and the display data flow, and driving a pixel unit to display image according to the gray-scale signal. The polarity signal is substantially DC-balanced. A display utilizing such method may reduce the influence of flicker phenomenon.

### BACKGROUND OF THE INVENTION

1. Field of the Invention

The present invention relates to liquid crystal display (LCD), and more specifically, to an LCD capable of reducing the influence of flicker phenomenon.

2. Description of the Prior Art

LCDs having a plurality of transistors and capacitors forming an array can display vivid images and are widely used throughout the world. The LCD panels, due to light weight, low power consumption, and absence of radiation, have increasingly replaced traditional CRT monitors and are also used extensively in portable electrical devices such as notebook computers and personal digital assistants, etc.

An LCD display includes two indium tin oxide sheets of glass (ITO glass) sandwiching a liquid crystal layer comprising liquid crystal molecules. One of the glass layers serves as a pixel electrode while the other as a common electrode. The alignment of the sandwiched liquid crystal molecules is changed as the voltage across the two electrodes changes. Therefore, various gray levels are resulted based on different light incidence conditions provided by different alignments of the liquid crystal molecules.

In general, as is well known in the art, the voltage across the two electrodes can be of two polarities. A voltage of the pixel electrode larger than that of the common electrode indicates a positive polarity, and inversely, a voltage of the common electrode larger than that of the pixel electrode indicates a negative polarity. If absolute values of the voltage differences across the two electrodes are the same, no matter which of the voltage value of the pixel electrode or that of the common electrode is higher, an identical gray level is obtained. However, as a matter of fact, voltage difference values across the two electrodes with opposite polarities result in opposite alignments of the liquid crystal molecules.

From a viewpoint of long-term averaging effect, if the voltage across the two electrodes appears to be either of the two polarities more often than the other polarity, an average DC constituent of a value other than zero across the two electrodes will be resulted, causing a voltage-drifting phenomenon to a common voltage Vcom on the common electrode. Consequently, the alignment of the liquid crystal molecules fails to follow the control of the designated control voltage, resulting in displaying incorrect gray levels. In an extreme case, if the unbalance between the two polarities lasts for too long a time, it is possible, even after the unbalance is removed, that the liquid crystal molecules cannot be correctly controlled according to applied electrical field, due to spoiled electrical characteristics.

As a result, in order to prevent the common voltage Vcom from experiencing the voltage-drifting phenomenon as the voltage applied across the two electrodes leans toward either of the polarities, the voltages across the two electrodes are designed to periodically switch between positive polarity and negative polarity. As shown in FIG. 1, various switching modes, such as frame toggling, line toggling, column toggling, and pixel toggling, are widely used for periodically driving the voltage across the liquid crystal molecules.

Please refer to FIG. 2, which shows a diagram of voltage applied on the liquid crystal molecules for a pixel unit based on the display data combined with the polarity using frame toggling. Utilizing such a mechanism, from a long-term view, the voltage across the two electrodes has a tendency toward even distribution and the DC constituent across the two electrodes tends toward zero, thereby the possibility of the common electrode voltage Vcom exhibiting the voltage-drifting phenomenon is minimized.

Nevertheless, under certain situations, a well-known phenomenon called “flicker” occurs when certain periodic input display data is combined with conventional periodic switch modes. Take pixel toggling as an example, in an extreme case, if a periodic data flow (FF, 00, FF, 00, . . . ) is inputted repeatedly, as is obvious to a skilled artisan in this art, the voltage applied across the two electrodes will predominantly appear in the direction of one of the polarities (positive polarity illustrated in FIG. 2), thereby the voltage-drifting phenomenon remains and display quality is reduced.

### SUMMARY OF THE INVENTION

It is therefore one of the objectives of the claimed invention to provide a Liquid Crystal Display (LCD) and method thereof, capable of reducing the influence of flicker phenomenon to improve the quality of image display.

According to embodiments of the present invention, a method for controlling a display device to display an image is disclosed. The method includes the steps of receiving a display data flow, generating a polarity signal, generating a gray-scale signal based on the polarity signal and the display data flow, and driving a pixel unit to display the image based on the gray-scale signal. The polarity signal is substantially DC-balanced.

According to embodiments of the present invention, a display apparatus is also disclosed. The display apparatus includes a plurality of pixel units and a logic unit for receiving a display data flow. The logic unit comprises a polarity signal generator for generating a polarity signal and a plurality of polarity mixers for generating a gray-scale signal based on the polarity signal and the display data flow to drive the plurality of pixel units.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows various switching modes for driving the voltage across the liquid crystal molecules.

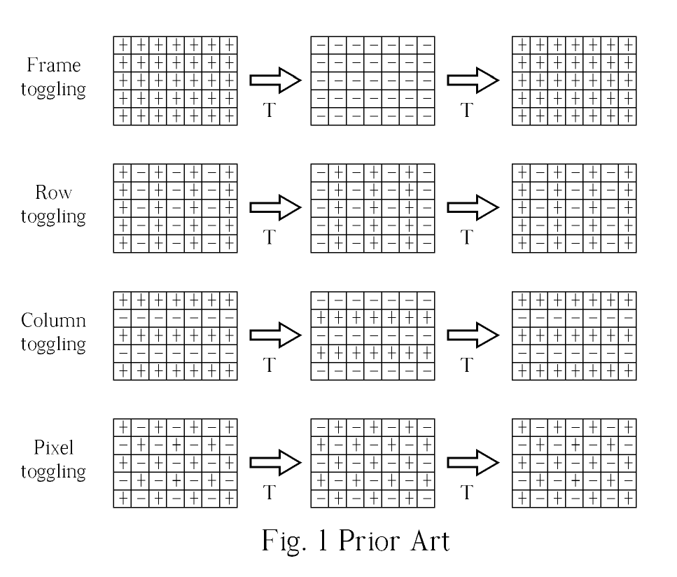

FIG. 2 shows a diagram of voltage applied on liquid crystal molecules of a pixel unit based on the display data combined with the polarity using frame toggling.

FIG. 3 is a functional block diagram of an embodiment of an LCD according to an embodiment of the present invention.

FIG. 4 is a structure diagram of the pixel unit in FIG. 3.

FIG. 5 is a functional block diagram of the logic unit illustrated in FIG. 3.

FIG. 6 is a diagram of a polarity signal generator shown in FIG. 5.

### DETAILED DESCRIPTION

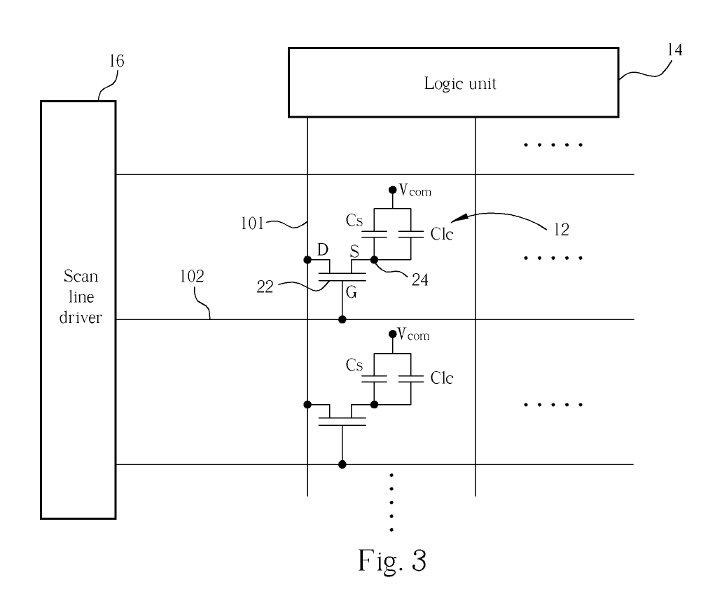

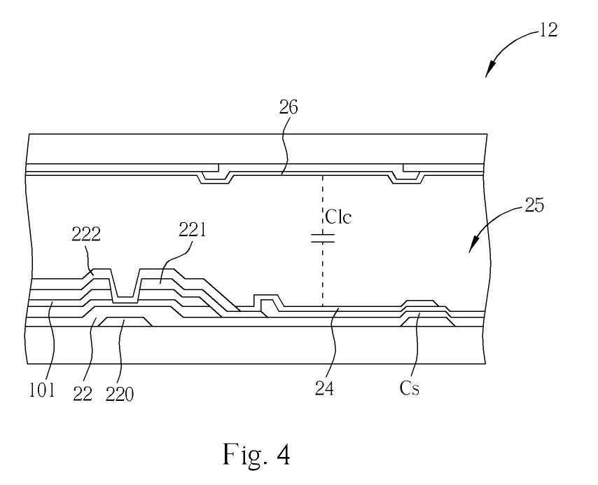

Please refer to FIG. 3 and FIG. 4. FIG. 3 is a functional block diagram of an embodiment of an LCD 10 according to the present invention. FIG. 4 is a structure diagram of an image pixel unit 12 in FIG. 3. The LCD 10 comprises a plurality of image pixel units 12 and a logic unit 14. Each image pixel unit 12 comprises a transistor 22, of which a gate 220 is electrically connected to a scan line 102, a drain 221 is electrically connected to a data line 101, and a source 222 is electrically connected to a pixel electrode 24. In FIG. 4, each image pixel unit 12 also comprises a pixel electrode 24, a liquid crystal layer 25, a common electrode 26, and a storage capacitor Cs. The liquid crystal layer 25 contains revolvable liquid crystal molecules. The pixel electrode 24 and the common electrode 26 are both electrically conductive glass plates, wherebetween a capacitor Clc is formed.

The scan line driver 16 subsequently sends a turn-on voltage through the scan lines 102 to turn on each row of the transistors 22. As the transistor 22 turns on, the logic unit 14 transmits the designated gray-scale signals for each image pixel unit 12 to the pixel electrode 24 through the data line 101, so that the storage capacitor Cs will charge to a desired voltage value. After the image pixel unit 12 at the last line has finished charging, the scan line driver 16 will go back and start a new cycle of charging from the first line. Taking an LCD with 60 Hz refresh frequency as an example, the display time for each frame is about 1/60=16.67 ms. In other words, the scan line driver 16 will recharge each line approximately every 16.67 ms. The alignment of the liquid crystal molecules in the liquid crystal layer 25 is changed based on a difference between the gray-scale signal and the common voltage value Vcom. The storage capacitor Cs is used to maintain the voltage difference as the transistor 22 is turned off, until the corresponding transistor 22 turns on again.

Please note that the functional block diagram of the LCD 10 and the structure diagram of the image pixel unit 12 shown in FIG. 3 and FIG. 4 respectively are examples of the present invention and should not be treated as limitations to the present invention. Any structures of pixel units and LCDs known by those skilled in this art, as long as conforming to the spirit of the invention, should be within the scope of the present invention.

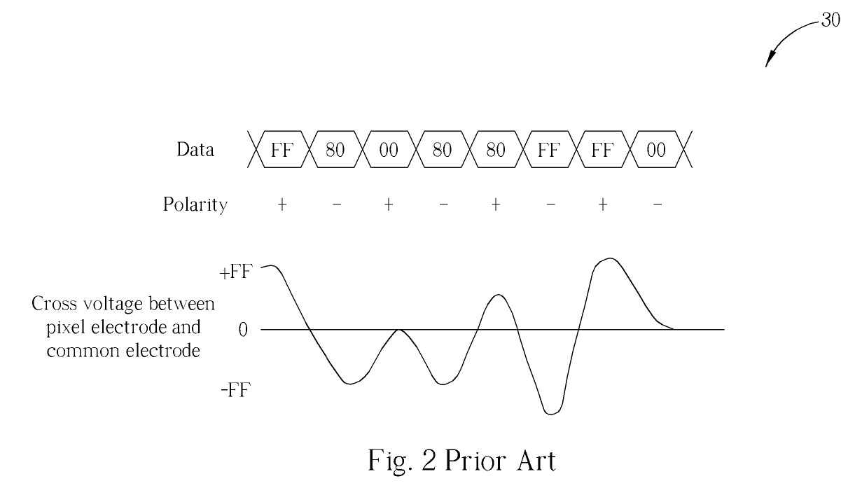

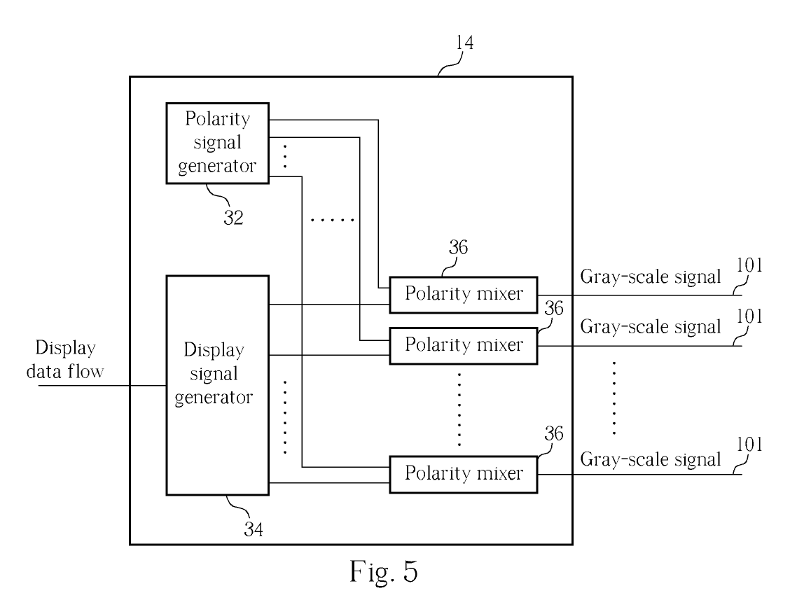

Please refer to FIG. 5. FIG. 5 is a functional block diagram of the logic unit 14 illustrated in FIG. 3. In this embodiment, the logic unit 14 comprises a display signal generator 34, a polarity signal generator 32, and a plurality of polarity mixers 36. The display signal generator 34 receives the display data and generates display signals corresponding to the pixel units for each line on the LCD panel based on the display data. Such display signals in digital form, as those in the data flow shown in FIG. 2, represent the magnitude of the gray-scale signals for driving the pixel unit 12. The polarity signal generator 32 is used to generate the polarity signals, which represent polarity of the gray-scale signal for driving image pixel unit 12. The polarity mixer 36 mixes the magnitude of the display signal with the polarity signal to generate the gray-scale signal for driving the plurality of pixel units 12. Please note that the polarity mixer 36 can be implemented by a digital to analog converter (DAC), a multiplier, or another electrical component.

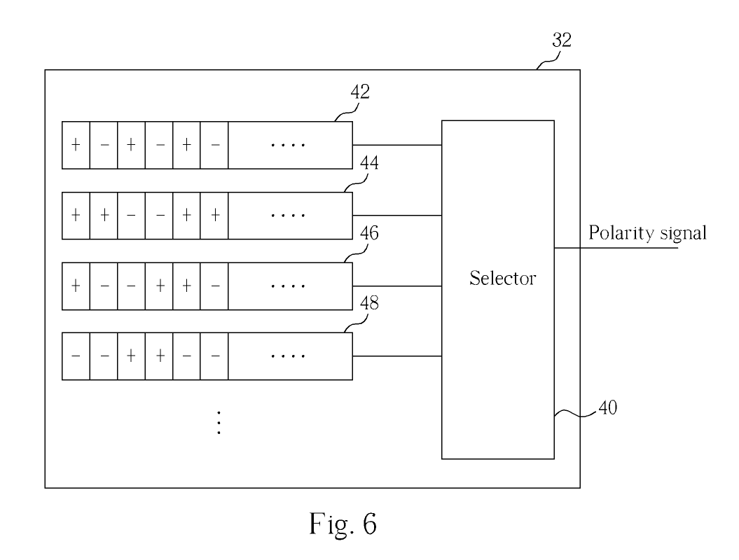

In this embodiment of the present invention, in order to achieve the goal of maintaining the voltage across two electrodes of each image pixel unit 12 to be of zero DC constituent in the long run, the polarity signal generator 32 is used for generating substantially DC-balanced polarity signals, i.e., the number of times that the positive polarity appears in the polarity signal is around the same number of times that the negative polarity appears in the polarity signal for a given long period of time. As one embodiment, the polarity signal generator 32 can be a random signal generator, which selects to output the positive polarity or the negative polarity in a randomly fashion. In another embodiment, the polarity signal generator 32 can also be implemented to, within different time periods, select different sequences from a plurality of DC-balanced polarity sequences. As shown in FIG. 6, the polarity signal generator 32 comprises a selector 40, which selects one sequence from a plurality of polarity sequences 42, 44, 46, 48. Please note that herein, a DC-balanced polarity sequence indicates a sequence of positive and negative polarities, which can be stored in registers or come from other sources, having a number of the positive polarity either equal to that of the negative polarity, or in close proximity to that of the negative polarity. The selector 40 can select from the plurality of sequences in a predetermined order, or randomly, or even select from a shifted version of one or more of the plurality of sequences.

A skilled person in this art should understand that the sequences shown in FIG. 6 merely serve as one embodiment of the present invention and are not meant limiting. Moreover, the selector 40 can also be utilized to switch among various modes such as frame toggling, line toggling, column toggling, and/or pixel toggling to output polarity signals. Besides, the selector 40 can determine the selecting order based on the characteristics of input display data (for example, whether it is periodic display data, or how long the period of the display data is), to prevent the common voltage Vcom from voltage-drifting phenomenon.

Utilizing the present inventive method, the polarity of gray-scale signals to be received by each pixel unit is more even, so that the possibility of occurrence of flicker phenomenon will be reduced.

Those skilled in the art will readily observe that numerous modifications and alterations of the device and method may be made while retaining the teachings of the invention. Accordingly, the above disclosure should be construed as limited only by the metes and bounds of the appended claims.

1. A method for controlling a display device to display an image, the method comprising:
receiving a display data flow;
generating a polarity signal; and
driving a pixel unit to display the image based on the polarity signal and the display data flow;
wherein the polarity signal is substantially DC-balanced.

2. The method of claim 1 further comprising:
generating a gray-scale signal based on the polarity signal and the display data flow; and
driving the pixel unit to display the image based on the gray-scale signal.

3. The method of claim 1 wherein the polarity signal is generated randomly.

4. The method of claim 1 wherein the step of generating the polarity signal comprises selecting one polarity sequence from a plurality of polarity sequences to generate the polarity signal.

5. The method of claim 4 wherein each of the plurality of polarity sequences is substantially DC-balanced.

6. The method of claim 4 wherein the selecting step is performed by selecting randomly.

7. The method of claim 4 wherein the selecting step is performed by selecting in a predetermined order.

8. The method of claim 1 wherein the polarity signal is generated based on the characteristics of the received display data flow.

9. The method of claim 1, wherein the display device is a liquid crystal display.

10. A display apparatus comprising:
a plurality of pixel units; and
a logic unit for receiving a display data flow comprising:
a polarity signal generator for generating a polarity signal; and
a plurality of polarity mixers for generating a gray-scale signal based on the polarity signal and the display data flow to drive the plurality of pixel units.

11. The display apparatus of claim 10 wherein the polarity signal is substantially DC-balanced.

12. The display apparatus of claim 10 herein the polarity signal generator generates the polarity signal randomly.

13. The display apparatus of claim 10 wherein the polarity signal generator comprises a selector for selecting one polarity sequence from a plurality of polarity sequences to generate the polarity signal.

14. The display apparatus of claim 13 wherein each polarity sequence is substantially DC-balanced.

15. The display apparatus of claim 13 wherein the selector selects one polarity sequence from the plurality of polarity sequences randomly.

16. The display apparatus of claim 13 wherein the selector selects one polarity sequence from the plurality of polarity sequences in a predetermined order.

17. The display apparatus of claim 13 wherein the polarity signal generator generates the polarity signal based on the character of the received display data flow.

18. The display apparatus of claim 10 is a liquid crystal display.
